(19) United States
(12) Patent Application Publication
(10) Pub. No.: US 2026/0246134 A1
(43) Pub. Date: Aug. 20, 2026

(54) MOUNTING STRUCTURE AND ANTENNA DEVICE

(71) Applicants: YOKOWO CO., LTD., Tokyo (JP); HONDA MOTOR CO., LTD., Tokyo (JP)

(72) Inventors: Kenji HAYAKAWA, Tomioka-shi, Gunma (JP); Koki KUBO, Tokyo (JP); Masaki SUTO, Tokyo (JP)

(73) Assignees: YOKOWO CO., LTD., Tokyo (JP); HONDA MOTOR CO., LTD., Tokyo (JP)

(21) Appl. No.: 19/165,412

(22) PCT Filed: Mar. 4, 2024
(86) PCT No.: PCT/JP2024/008090

§ 371 Date: Sep. 15, 2025

(30) Foreign Application Priority Data
Mar. 20, 2023 (JP) 2023-043800

(51) Int. Cl. H01Q 1/12

(52) U.S. Cl. CPC H01Q 1/1271

(57) ABSTRACT

A mounting structure including an accommodation portion accommodating a substrate, a fastening portion to fasten the accommodation portion and a ground plate to each other, a locking portion to be locked to the ground plate by a fastening operation of the fastening portion, and a restricting portion to restrict a movement direction of the locking portion during the fastening operation of the fastening portion.

### TECHNICAL FIELD

The present invention relates to a mounting structure and an antenna device.

### BACKGROUND ART

In recent years, various mounting structures have been developed. As described in Patent Document 1, for example, a mounting structure to a vehicle attaches an amplifier substrate electrically connected to an antenna element such as an amplitude modulation/frequency modulation (AM/FM) radio broadcasting antenna, and a ground plate such as a frame of an automobile to each other. In the mounting structure disclosed in Patent Document 1, an antenna base accommodating an amplifier substrate and a vehicle panel are fixed to each other by a mounting screw.

RELATED DOCUMENT

### Patent Document

Patent Document 1: Japanese Unexamined Patent Publication No. 2013-251791

### SUMMARY OF THE INVENTION

### Technical Problem

For example, an accommodation portion that accommodates a substrate such as an amplifier substrate and a ground plate such as a frame of a vehicle may be fastened to each other by fastening portions such as bolts and nuts. The attachment of the accommodation portion and the ground plate requires not only to improve the mounting work of the accommodation portion and the ground plate but also to stably ground a device including a substrate such as an amplifier substrate to the ground plate.

An example of the object of the present invention is to stably ground a device including a substrate to a ground plate when attaching an accommodation portion that accommodates the substrate such as an amplifier substrate, and the ground plate such as a frame of a vehicle. Another object of the invention will be clearly shown from the disclosure of the present specification.

### Solution to Problem

An aspect of the present invention is a mounting structure including:
an accommodation portion accommodating a substrate;
a fastening portion to fasten the accommodation portion and a ground plate to each other;
a locking portion to be locked to the ground plate by a fastening operation of the fastening portion; and
a restricting portion to restrict a movement direction of the locking portion during the fastening operation of the fastening portion.

An aspect of the present invention is an antenna device including:
the mounting structure; and
an antenna electrically connected to the substrate.

An aspect of the present invention is a mounting structure including:
an accommodation portion accommodating a substrate and including an outer surface;
a fastening portion to fasten the accommodation portion and a ground plate to each other; and
a locking portion to be locked to the ground plate by a fastening operation of the fastening portion,
wherein the locking portion moves along the outer surface of the accommodation portion in the fastening operation of the fastening portion.

According to the mounting structure and antenna device in the aspects described above of the present invention, the device including a substrate such as an amplifier substrate can be stably grounded to the ground plate.

### BRIEF DESCRIPTION OF THE DRAWINGS

FIG. 1 A view of an upper rear part of a vehicle equipped with an antenna device according to an embodiment as viewed from an inside of the vehicle.

FIG. 2 A left side view of an upper rear part of a vehicle equipped with the antenna device according to the embodiment.

FIG. 3 A perspective view of the mounting structure according to the embodiment.

FIG. 4 A cross-sectional view taken along line A-A of FIG. 3.

FIG. 5 An exploded perspective view of a part of the mounting structure according to the embodiment.

FIG. 6 A view for describing an example of a method of attaching the accommodation portion and the ground plate to each other by the mounting structure according to the embodiment.

FIG. 7 A view for describing an example of a method of attaching the accommodation portion and the ground plate to each other by the mounting structure according to the embodiment.

FIG. 8 A view for describing an example of a method of attaching the accommodation portion and the ground plate to each other by the mounting structure according to the embodiment.

FIG. 9 A perspective view of a mounting structure according to Variant 1.

FIG. 10 An exploded perspective view of a part of a mounting structure according to Variant 2.

### DESCRIPTION OF EMBODIMENTS

Hereinafter, embodiments and variants of the present invention is described with reference to the accompanying drawings. In all the drawings, the same constitutional components are denoted by the same reference signs, and description thereof is not repeated as appropriate.

In the embodiment, a mounting structure of an amplifier attached to a vehicle and an antenna device is described as an example of the present invention. The mounting structure of the present invention can be applied to any device that includes a substrate, not just amplifiers, and can be applied to any article that has a ground plate, not just vehicles. In addition, the antenna device of the present invention can be applied to any article that has a ground plate, not just vehicles.

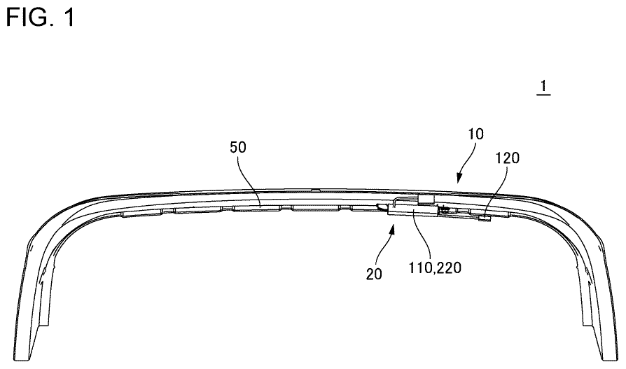

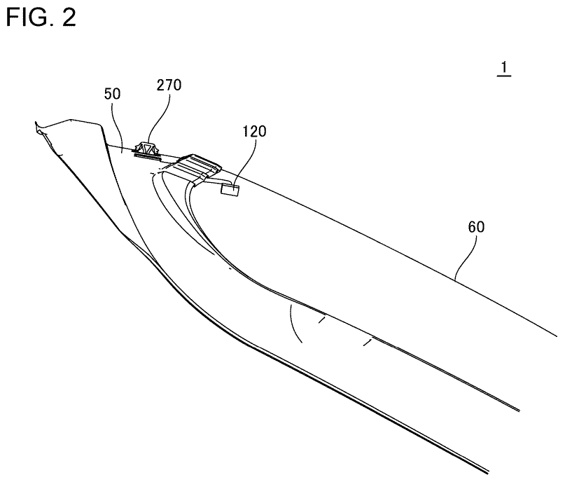

FIG. 1 is a view of an upper rear part of a vehicle 1 equipped with an antenna device 10 according to an embodiment as viewed from an inside of the vehicle 1. FIG. 2 is a left side view of an upper rear part of the vehicle 1 equipped with the antenna device 10 according to the embodiment.

The vehicle 1 includes a ground plate 50 and a rear window 60. In the examples shown in FIG. 1 and FIG. 2, the ground plate 50 is a frame of a tailgate of the vehicle 1. The rear window 60 is attached to the ground plate 50. The ground plate 50 is not limited to the frame of the tailgate of a vehicle. The ground plate 50 may be a portion other than the frame of the tailgate in the frame of the body of the vehicle 1, such as a pillar frame, for example.

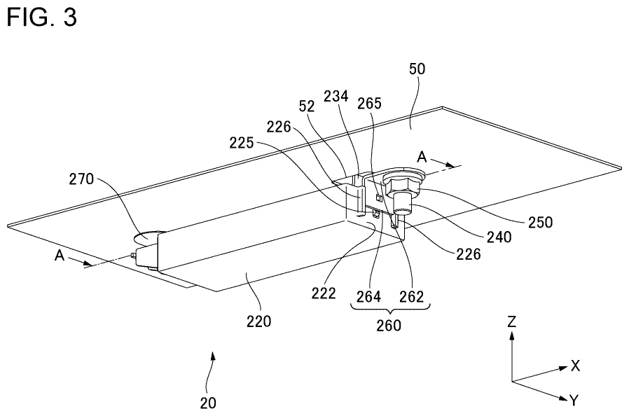

The antenna device 10 according to the embodiment includes a glass antenna provided on the rear window 60, an amplifier substrate 110, and an antenna terminal 120. The glass antenna is configured by a conductor pattern provided on the rear window 60, for example. The glass antenna is an Amplitude Modulation/Frequency Modulation (AM/FM) radio antenna, for example. The amplifier substrate 110 is covered with a cover 220, the details of which will be described later with reference to FIG. 3 to FIG. 8. The glass antenna and the amplifier substrate 110 are electrically connected to each other through the antenna terminal 120. The antenna terminal 120 is drawn from the cover 220 toward the rear window 60. The amplifier substrate 110 and the ground plate 50 are attached to each other by a mounting structure 20, the details of which will be described later with reference to FIG. 3 to FIG. 8.

In the embodiment, the glass antenna and the amplifier substrate 110 are electrically connected to each other.

However, the amplifier substrate 110 may be electrically connected to an antenna of a different type from the glass antenna.

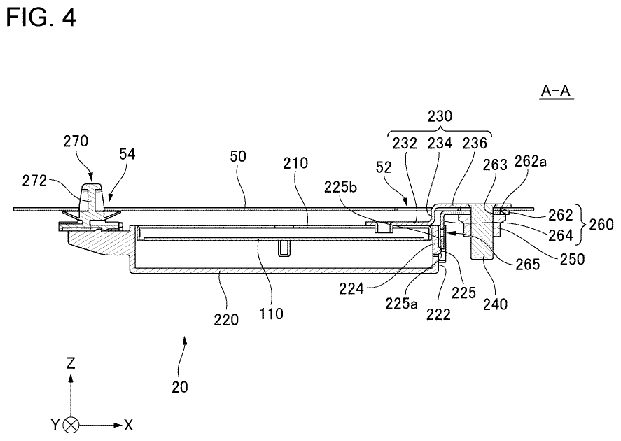

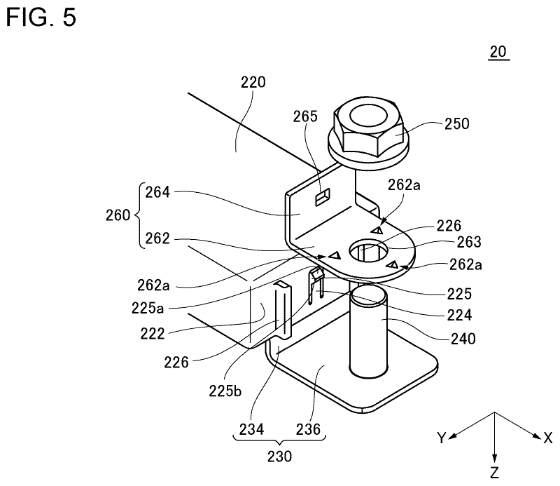

FIG. 3 is a perspective view of the mounting structure 20 according to the embodiment. FIG. 4 is a cross-sectional view taken along line A-A of FIG. 3. FIG. 5 is an exploded perspective view of a part of the mounting structure 20 according to the embodiment.

Each drawing depicts an X-axis, a Y-axis, and a Z-axis indicating the X direction, the Y direction, and the Z direction respectively for description. The Z direction is a direction perpendicular to the ground plate 50. The X direction is one of directions perpendicular to the Z direction. The Y direction is a direction perpendicular to the Z direction and the X direction. Hereinafter, as necessary, a side indicated by the arrow of the X-axis is referred to as a +X side, and a side opposite to the side indicated by the arrow of the X-axis is referred to as a −X side. Hereinafter, as necessary, a side indicated by the arrow of the Y-axis is referred to as a +Y side, and a side opposite to the side indicated by the arrow of the Y-axis is referred to as a −Y side. Hereinafter, as necessary, a side indicated by the arrow of the Z-axis is referred to as a +Z side, and a side opposite to the side indicated by the arrow of the Z-axis is referred to as a −Z side. In FIG. 4, the white circle with X indicating the Y axis indicates that the arrow of the Y axis points from the front to the back of the paper surface.

In the embodiment, the +Z side is substantially above in the vertical direction, and the −Z side is substantially below in the vertical direction. However, the Z direction may be parallel to a direction different from the vertical direction.

Hereinafter, as necessary, a plane perpendicular to the Z direction is referred to as an XY plane, a plane perpendicular to the X direction is referred to as a YZ plane, and a plane perpendicular to the Y direction is referred to as a ZX plane.

The mounting structure 20 will be described with reference to FIG. 3 to FIG. 5. The mounting structure 20 according to the embodiment has a chassis 210, a cover 220, a bracket 230, a bolt 240, a nut 250, a washer 260, and a mounting portion 270.

The mounting structure 20 according to the embodiment is a structure that accommodates the amplifier substrate 110 and other components as necessary in an accommodating space formed by the chassis 210 and the cover 220, and that attaches the chassis 210 and the cover 220 to the ground plate 50. As shown in FIG. 4, the ground plate 50 defines a first mounting hole 52 and a second mounting hole 54. In the embodiment, the ground plate 50 is a frame of the vehicle 1 as described with reference to FIG. 1 and FIG. 2. An insulating film such as a coating film is provided on the surface of the ground plate 50. However, the mounting structure 20 according to the embodiment can also be applied to a ground plate different from the frame of the automobile such as the vehicle 1. Hereinafter, unless otherwise specified, the ground plate 50 is described as the frame of the automobile.

The chassis 210 is made of a conductor such as metal, for example. The chassis 210 has a substantially rectangular shape having a long side substantially parallel to the X direction and a short side substantially parallel to the Y direction as viewed from the Z direction. However, the shape of the chassis 210 is not limited to this example. The amplifier substrate 110 is located on a −Z side surface side of the chassis 210.

The cover 220 is made of an insulator such as a resin, for example. As shown in FIG. 4, the cover 220 covers the amplifier substrate 110 from the −Z side. As shown in FIG. 3, the cover 220 has a substantially rectangular parallelepiped shape having a long side substantially parallel to the X direction, a short side substantially parallel to the Y direction, and a height substantially parallel to the Z direction. However, the shape of the cover 220 is not limited to this example. The cover 220 is open toward the +Z side. The chassis 210 and the opening of the cover 220 on the +Z side are engaged with each other. The chassis 210 and the cover 220 are accommodation portions that accommodate the amplifier substrate 110.

As shown in FIG. 3 to FIG. 5, the cover 220 has a first outer side surface 222. The first outer side surface 222 is an outer surface of the cover 220 on the +X side.

As shown in FIG. 3 to FIG. 5, a first engaging portion 224 is provided on the first outer side surface 222. The first engaging portion 224 is located at a substantially center portion of the first outer side surface 222 in the Y direction. When an external force is not applied to the first engaging portion 224, the first engaging portion 224 extends substantially parallel to the Z direction. The first engaging portion 224 and an engagement hole 265 described later can be bonded to each other by snap-fitting. The first engaging portion 224 according to the embodiment is a cantilever that can be engaged with the engagement hole 265. However, the engaging structure that enables the first engaging portion 224 and the engagement hole 265 to be engaged with each other is not limited to the example of the snap-fit structure, and may be any structure as long as the engaging structure has at least one of a positioning function when temporarily fixing the bolt 240 and the nut 250, an anti-rotation function of restricting a movement direction of the washer 260 when temporarily fixing the bolt 240 and the nut 250, or a holding function of the washer 260 when temporarily fixing the bolt 240 and the nut 250, which will be described later.

As shown in FIG. 3 to FIG. 5, a first engaging claw 225 is provided at the −Z side end portion of the first engaging portion 224. The first engaging claw 225 protrudes from the −Z side end portion of the first engaging portion 224 toward the +X side. When the external force is applied to the first engaging claw 225 toward the −X side, the first engaging claw 225 is biased toward the +X side by the elasticity of the first engaging portion 224. The first engaging claw 225 can be engaged with the engagement hole 265 from the −X side. As shown in FIG. 4 and FIG. 5, the first engaging claw 225 includes a first inclined surface 225a and a second inclined surface 225b. The first inclined surface 225a is a side surface of the first engaging claw 225 on the −Z side. The first inclined surface 225a is inclined with respect to the X direction as viewed from the Y direction. Specifically, the first inclined surface 225a is inclined to the +Z side toward the +X side as viewed from the Y direction. The second inclined surface 225b is a side surface of the first engaging claw 225 on the +Z side. The second inclined surface 225b is inclined with respect to the X direction as viewed in the Y direction. Specifically, the second inclined surface 225b is inclined to the −Z side toward the +X side as viewed from the Y direction. As a result, the first engaging claw 225 has a tapered shape decreasing in the width of the first engaging claw 225 in the Z direction toward the +X side as viewed in the Y direction. As the extending portion 264 of the washer 260, which will be described later, is moved toward the +Z side with the first engaging claw 225 and the engagement hole 265 engaged with each other, the −Z side inner side surface of the engagement hole 265 is in contact with and slide on the first inclined surface 225a to push the first engaging claw 225 toward the −X side. The engagement between the first engaging claw 225 and the engagement hole 265 is released accordingly.

As shown in FIG. 3 and FIG. 5, a pair of first ribs 226 is provided on the first outer side surface 222. The pair of first ribs 226 is located on both sides of the first engaging portion 224 in the Y direction. Each first rib 226 extends substantially parallel to the Z direction. Each of the pair of first ribs 226 protrudes from the first outer side surface 222 toward the +X side. The interval between the pair of first ribs 226 in the Y direction is an interval at which the extending portion 264 of the washer 260 described below can be located between the pair of first ribs 226 in the Y direction. In addition, the pair of first ribs 226 enables the extending portion 264 of the washer 260 described below to move in the Z direction while restraining the extending portion 264 of the washer 260 described below from moving in the X direction. The length of each of the pair of first ribs 226 in the Z direction is substantially the same as the length of the extending portion 264 of the washer 260 described below in the Z direction.

The bracket 230 is made of a conductor such as metal, for example. As shown in FIG. 4, the bracket 230 includes a proximal end portion 232, a stepped portion 234, and a drawn portion 236. Each of the proximal end portion 232 and the drawn portion 236 has a substantially plate shape substantially parallel to the XY plane. The stepped portion 234 has a substantially plate shape substantially parallel to the YZ plane. As viewed from the Y direction, the +X side end portion of the proximal end portion 232 and the −Z side end portion of the stepped portion 234 are bent substantially at a right angle to each other. As viewed from the Y direction, the +Z side end portion of the stepped portion 234 and the −X side end portion of the drawn portion 236 are bent at substantially a right angle to each other.

As shown in FIG. 4, the proximal end portion 232 is located on the −Z side with respect to the −Z side surface of the ground plate 50. The proximal end portion 232 and the +X side end portion of the +Z side surface of the chassis 210 are attached to each other. As a result, the bracket 230 and the amplifier substrate 110 are electrically connected to each other via the chassis 210. As shown in FIG. 3 and FIG. 4, the stepped portion 234 extends through the first mounting hole 52 in a direction substantially parallel to the Z direction. As shown in FIG. 4, the drawn portion 236 is located on the +Z side with respect to the +Z side surface of the ground plate 50. In the example shown in FIG. 4, the −Z side surface of the drawn portion 236 and the +Z side surface of the ground plate 50 are in contact with each other.

The bolt 240 and the nut 250 are fastening portions that fasten a set of the chassis 210, the cover 220, and the bracket 230 that are integrated, the washer 260, and the ground plate 50 to each other. In the example shown in FIG. 3 and FIG. 4, the set of the chassis 210, the cover 220, and the bracket 230 that are integrated, the washer 260, and the ground plate 50 are fastened to each other by the bolt 240 and the nut 250.

The bolt 240 is made of a conductor such as metal, for example. The bolt 240 extends substantially parallel to the Z direction. As a result, a fastening direction of the fastening portion including the bolt 240 and the nut 250 is substantially parallel to the Z direction. The bolt 240 extends through the first mounting hole 52 substantially parallel to the Z direction. Accordingly, the −Z side end portion of the bolt 240 is located on the −Z side with respect to the −Z side surface of the ground plate 50. The +Z side end portion of the bolt 240 is inserted into a hole provided in the drawn portion 236. The +Z side end portion of the bolt 240 inserted into the hole and the drawn portion 236 are integrated with each other by a joining method such as caulking or welding. The +Z side end portion of the bolt 240 and the drawn portion 236 are electrically connected to each other. The method of integrally attaching the chassis 210, the cover 220, and the bolt 240 is not limited to this example.

The nut 250 is made of a conductor such as metal, for example. The nut 250 can be attached to the bolt 240 from the −Z side end portion of the bolt 240 by rotating the nut 250 around the bolt 240 in a tightening direction of the bolt 240 and the nut 250. In the examples shown in FIG. 3 and FIG. 4, the outer side surface of the bolt 240 and the inner side surface of the nut 250 are electrically connected to each other.

In the embodiment, the set of chassis 210 and cover 220 that are integrated, and the bolt 240 are attached to each other via the bracket 230. The bolt 240 and the nut 250 are attachable to and detachable from each other. As a result, the set of the chassis 210 and the cover 220 that are integrated and the ground plate 50 can be fastened to each other by the bolt 240 and the nut 250 without being joined in advance by a joining method such as welding.

The washer 260 is made of a conductor such as metal, for example. The washer 260 is a locking portion that is locked to the ground plate 50 by the fastening operation of the bolt 240 and the nut 250. The washer 260 includes a contact portion 262 and an extending portion 264. The contact portion 262 has a substantially plate shape substantially parallel to the XY plane. The extending portion 264 has a substantially plate shape substantially parallel to the YZ plane. As viewed from the Y direction, the −X side end portion of the contact portion 262 and the +Z side end portion of the extending portion 264 are bent at substantially right angles to each other. As a result, the washer 260 has a substantially L-shape as viewed in the Y direction.

The contact portion 262 is located on the −Z side with respect to the −Z side surface of the ground plate 50. The contact portion 262 defines a through-hole 263. The bolt 240 extends through the through-hole 263 substantially parallel to the Z direction. As shown in FIG. 5, the contact portion 262 includes three contact claws 262a. The three contact claws 262a are located on the +Z side surface of the contact portion 262. The three contact claws 262a are disposed at substantially equal intervals around the through-hole 263 as viewed in the Z direction. Each contact claw 262a has a substantially triangular pyramid shape. However, the number, arrangement, and shape of the contact claws 262a are not limited to this example. In the embodiment, each contact claw 262a is formed by partially pressing the −Z side surface of the contact portion 262. FIG. 5 shows three recesses, corresponding to the three contact claws 262a, formed on the −Z side surface of the contact portion 262 by the pressing. The contact portion 262 may not include the contact claw 262a.

As shown in FIG. 5, the extending portion 264 is slidable in a direction substantially parallel to the Z direction along the first outer side surface 222 between the pair of first ribs 226. The extending portion 264 defines an engagement hole 265.

In the example shown in FIG. 3 and FIG. 4, the contact portion 262 and the ground plate 50 are locked to each other by the fastening operation of the bolt 240 and the nut 250. When the bolt 240 and the nut 250 are fastened to each other, the ground plate 50 is held in the Z direction by the drawn portion 236 and the contact portion 262. As a result, each contact claw 262a can contact the −Z side surface of the ground plate 50 and break the insulating film such as the coating film on the −Z side surface of the ground plate 50. Accordingly, the washer 260 and the ground plate 50 can be electrically connected to each other with ease and reliability as compared with the case where the contact claw 262a is not provided. The amplifier substrate 110 and the ground plate 50 can be electrically connected to each other through the chassis 210, the bracket 230, the bolt 240, the nut 250, and the washer 260 by the electrical connection between the washer 260 and the ground plate 50.

The mounting portion 270 is provided on the side surface of the cover 220 on the −X side. The mounting portion 270 is attached to the second mounting hole 54. Specifically, as shown in FIG. 4, the mounting portion 270 has a mounting extending portion 272 that extends through the second mounting hole 54 substantially parallel to the Z direction. A protruding portion (not shown in FIG. 4) is provided at a portion of the mounting extending portion 272 located above the second mounting hole 54. The protruding portion is biased in a direction substantially perpendicular to the Z direction from the portion of the mounting extending portion 272. The mounting portion 270 is attached to the second mounting hole 54 by contacting the −Z side lateral portion of the protruding portion and the +Z side surface of the ground plate 50. However, the method of attaching the mounting portion 270 to the second mounting hole 54 is not limited to this example.

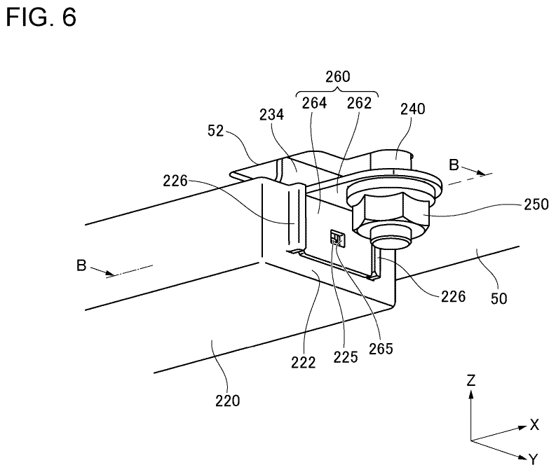

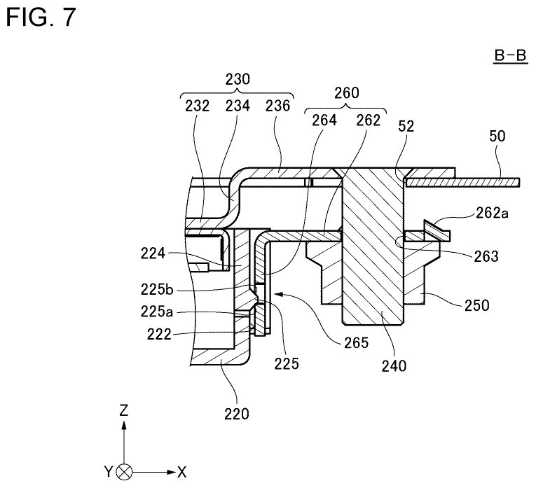

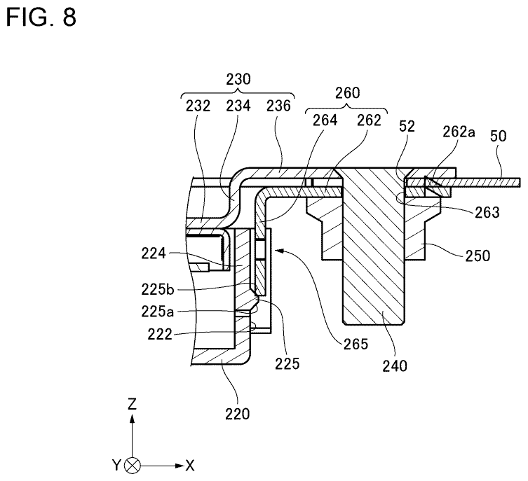

FIG. 6 to FIG. 8 are diagrams for describing an example of a method of attaching the amplifier substrate 110 and the ground plate 50 to each other by the mounting structure 20 according to the embodiment. FIG. 7 is a cross-sectional view taken along line B-B of FIG. 6. FIG. 8 is an enlarged view of a portion of FIG. 4.

An example of a method of attaching the amplifier substrate 110 and the ground plate 50 to each other by the mounting structure 20 according to the embodiment will be described with reference to FIG. 6 to FIG. 8.

First, a chassis 210, a bracket 230, and bolts 240 that are integrated in advance are prepared. In the integrated chassis 210 and bracket 230, the −X side end portion of the +Z side surface of the chassis 210 and the proximal end portion 232 of the bracket 230 are integrated with each other by a joining method such as caulking or welding. In the integrated bracket 230 and bolt 240, the drawn portion 236 of the bracket 230 and the +Z side end portion of the bolt 240 are integrated with each other by a joining method such as caulking or welding.

Next, the amplifier substrate 110 is mounted on the −Z side surface of the chassis 210. Next, the chassis 210 and the +Z side opening of the cover 220 are attached to each other. As the chassis 210 and the +Z side opening of the cover 220 are attached, the amplifier substrate 110 is accommodated in an accommodation space formed by the chassis 210 and the cover 220.

Next, as shown in FIG. 6 and FIG. 7, the washer 260 is temporarily held by the cover 220, the bracket 230, the bolt 240, and the nut 250. Specifically, first, the −Z side end part of the bolt 240 is passed through the through-hole 263 of the contact portion 262. Next, the first engaging claw 225 and the engagement hole 265 are engaged with each other. Next, the nut 250 is rotated around the bolt 240 in a tightening direction of the bolt 240 and the nut 250 to temporarily fasten the bolt 240 and the nut 250 to each other. The temporary tightening of the bolt 240 and the nut 250 can prevent the washer 260 from being detached from the bolt 240. When the first engaging claw 225 and the engagement hole 265 are engaged with each other, the first engaging claw 225 is a restricting portion that restricts the movement direction of the washer 260 to the Z direction. In the temporary tightening of the bolt 240 and the nut 250, therefore, the washer 260 can be inhibited from rotating around the bolt 240 even if the nut 250 rotates around the bolt 240.

In the example shown in FIG. 6 and FIG. 7, the position of the drawn portion 236 in the Z direction is displaced to the +Z side with respect to the position of the proximal end portion 232 in the Z direction by the stepped portion 234. As a result, the length of the clearance in the Z direction between the −Z side surface of the drawn portion 236 and the +Z side surface of the contact portion 262 can be easily increased as compared with the case where the position of the drawn portion 236 in the Z direction and the position of the proximal end portion 232 in the Z direction are aligned in the Z direction. Accordingly, the clearance between the −Z side surface of the ground plate 50 and the +Z side surface of the chassis 210 can be secured and the first mounting hole 52 of the ground plate 50 can be made smaller.

Next, as shown in FIG. 6 and FIG. 7, the +X side end portion of the drawn portion 236 is passed through the first mounting hole 52 from the −Z side of the ground plate 50. Next, the drawn portion 236 is placed on the +Z side surface side of the ground plate 50.

Next, the mounting portion 270 is attached to the second mounting hole 54 of the ground plate 50.

Next, as shown in FIG. 8, the nut 250 is rotated around the bolt 240 in a fastening direction of the bolt 240 and the nut 250 to fasten the bolt 240 and the nut 250 to each other. The nut 250 moves toward the +Z side by rotating the nut 250 around the bolt 240 in a tightening direction of the bolt 240 and the nut 250. The contact portion 262 is lifted toward the +Z side by the nut 250 until the +Z side surface of the contact portion 262 and the −Z side surface of the ground plate 50 contact with each other. As a result, the contact claw 262a can contact the −Z side surface of the ground plate 50, and the insulating film such as the coating film on the −Z side surface of the ground plate 50 can be broken by the contact claw 262a. Accordingly, the washer 260 and the ground plate 50 can be easily electrically connected to each other as compared with the case where the contact claw 262a is not provided.

In the fastening operation of the bolt 240 and the nut 250, the extending portion 264 slides substantially parallel to the Z direction along the first outer side surface 222 between the pair of first ribs 226. As a result, the pair of first ribs 226 and the extending portion 264 are restricting portions that restrict the movement direction of the washer 260 to the Z direction during the fastening operation of the bolt 240 and the nut 250. The washer 260 during the fastening operation of the bolt 240 and the nut 250 moves along the first outer side surface 222. In the fastening operation of the bolt 240 and the nut 250, therefore, the washer 260 can be inhibited from rotating around the bolt 240 even if the nut 250 rotates around the bolt 240. Accordingly, the amplifier substrate 110 can be stably grounded to the ground plate 50 as compared with the case where the washer 260 is rotated around the bolt 240. The configuration of the restricting portion may be a pair of first ribs 226 and the extending portion 264, and the first engaging claw 225 may not be included in the configuration of the restricting portion.

In the embodiment, the contact position between each contact claw 262a and the ground plate 50 can also be restricted by restricting the movement direction of the washer 260 during the fastening operation of the bolt 240 and the nut 250 to the Z direction. In the embodiment, therefore, the variation in the contact position between each contact claw 262a and the ground plate 50 can be reduced as compared with the case where the washer 260 rotates around the bolt 240. As a result, the electrical connection between the washer 260 and the ground plate 50 can be easily stabilized as compared with the case where the washer 260 rotates around the bolt 240.

The first rib 226 may not be provided on opposite sides of the extending portion 264 in the Y direction. For example, the first rib 226 may be provided only on one of the opposite sides of the extending portion 264 in the Y direction according to the rotation direction of the nut 250 during the fastening operation of the bolt 240 and the nut 250. When the nut 250 rotates clockwise in fastening the bolt 240 and the nut 250 as viewed from the −Z side, for example, the first rib 226 may not be provided on the +Y side of the extending portion 264 but the first rib 226 may be provided only on the −Y side of the extending portion 264. In this example, the washer 260 can be also inhibited from rotating around the bolt 240 as compared with the case where the first rib 226 is not provided on the opposite sides of the extending portion 264 in the Y direction.

In the embodiment, the pair of first ribs 226 has a structure that restricts the movement direction of the washer 260 to the Z direction during the fastening operation of the bolt 240 and the nut 250. However, this structure may be a structure different from the pair of first ribs 226 as long as the structure is located at least in part around the Z direction, which is the movement direction of the washer 260.

As shown in FIG. 7 and FIG. 8, in the fastening operation of the bolt 240 and the nut 250, the −Z side inner surface of the engagement hole 265 contacts with and slides on the first inclined surface 225a, thereby pushing the first engaging claw 225 toward the −X side. Accordingly, the −Z side inner side surface of the engagement hole 265 can easily contact with and slide on the first inclined surface 225a and can easily push the first engaging portion 224 toward the −X side as compared with the case where the first inclined surface 225a is parallel to the X direction as viewed from the Y direction. As a result, the engagement between the first engaging claw 225 and the engagement hole 265 can be easily released by the fastening operation of the bolt 240 and the nut 250 as compared with the case where the first inclined surface 225a is parallel to the X direction as viewed from the Y direction.

As shown in FIG. 8, when the bolt 240 and the nut 250 are fastened to each other, the −Z side end portion of the extending portion 264 and the second inclined surface 225b of the first engaging claw 225 are in contact with each other. In the example shown in FIG. 8, the inclination of the second inclined surface 225b can make it easier for the −Z side end part of the extending portion 264 and the second inclined surface 225b of the first engaging claw 225 to push against each other as compared with the case where the second inclined surface 225b is parallel to the X direction as viewed from the Y direction. As a result, the collision between the −Z side end portion of the extending portion 264 and the second inclined surface 225b of the first engaging claw 225 due to vibration can be suppressed as compared with the case where a minute clearance is present between the −Z side end portion of the extending portion 264 and the second inclined surface 225b of the first engaging claw 225. Accordingly, the occurrence of a strange sound due to the collision between the −Z side end part of the extending portion 264 and the second inclined surface 225b of the first engaging claw 225 due to vibration can be easily suppressed as compared with the case where the minute clearance is present.

The method of suppressing the occurrence of the strange sound due to the collision between the −Z side end part of the extending portion 264 and the second inclined surface 225b of the first engaging claw 225 is not limited to the example described above. For example, the −Z side end portion of the extending portion 264 and the second inclined surface 225b of the first engaging claw 225 may be spaced from each other to such an extent that the −Z side end portion of the extending portion 264 and the second inclined surface 225b of the first engaging claw 225 do not collide with each other even if vibration occurs.

Next, an example of a method of exchanging the washer 260 in the embodiment will be described.

First, the nut 250 is rotated around the bolt 240 in a direction opposite to a direction in which the bolt 240 and the nut 250 are fastened to each other, to loosen the bolt 240 and the nut 250. The nut 250 moves toward the −Z side by rotating the nut 250 around the bolt 240 in the direction opposite to the direction in which the bolt 240 and the nut 250 are fastened to each other. The contact portion 262 moves toward the −Z side together with the nut 250 due to the weight of the contact portion 262. In the embodiment, the −Z side end portion of the extending portion 264 and the second inclined surface 225b of the first engaging claw 225 are in contact with each other. As a result, the contact portion 262 can be moved toward the −Z side together with the nut 250 with the −Z side end portion of the extending portion 264 hooked on the second inclined surface 225b. In the embodiment, therefore, the washer 260 can be prevented from falling off when loosening the bolt 240 and the nut 250 from each other as compared to the case where the −Z side end portion of the extending portion 264 and the second inclined surface 225b of the first engaging claw 225 are spaced from each other by a relatively long distance.

Next, the nut 250 is detached from the −Z side end portion of the bolt 240. Next, the washer 260 is detached from the cover 220 and the bolt 240. Next, a new washer 260 is prepared. The new washer 260 is locked to the ground plate 50 in the same manner as the method described above. In this method, the washer 260 can be replaced without removing the amplifier substrate 110.

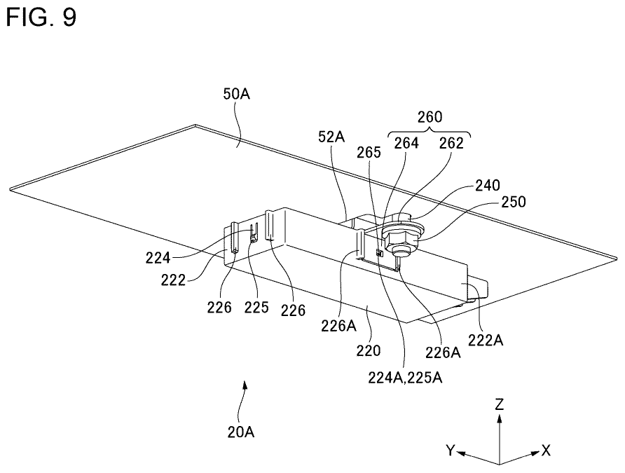

FIG. 9 is a perspective view of a mounting structure 20A according to Variant 1. The mounting structure 20A according to Variant 1 is the same as the mounting structure 20 according to the embodiment except for the following points.

The mounting structure 20A according to Variant 1 attaches the amplifier substrate 110 and the ground plate 50A to each other. The ground plate 50A defines a mounting hole 52A.

The cover 220 has a second outer side surface 222A. The second outer side surface 222A is an outer surface of the cover 220 on the +Y side. A second engaging portion 224A and a pair of second ribs 226A are provided on the second outer side surface 222A. The second engaging portion 224A corresponds to the first engaging portion 224. The second engaging portion 224A is located at a substantially center portion of the second outer side surface 222A in the X direction. A second engaging claw 225A is provided at the −Z side end portion of the second engaging portion 224A. The second engaging claw 225A corresponds to the first engaging claw 225. The pair of second ribs 226A corresponds to the pair of first ribs 226.

In the mounting structure 20A according to Variant 1, as in the mounting structure 20 according to the embodiment, the set of the chassis 210, the cover 220, and the bracket 230 that are integrated, the washer 260, and the ground plate 50A can be also fastened to each other by the bolt 240 and the nut 250. In the mounting structure 20A according to Variant 1, as in the mounting structure 20 according to the embodiment, the movement direction of the washer 260 can be also restricted to the Z direction in the fastening operation of the bolt 240 and the nut 250. The washer 260 during the fastening operation of the bolt 240 and the nut 250 is moved along the second outer side surface 222A. In the mounting structure 20A according to Variant 1, therefore, the amplifier substrate 110 can be also stably grounded to the ground plate 50 as compared with the case where the washer 260 rotates around the bolt 240 as in the mounting structure 20 according to the embodiment.

In the mounting structure 20A according to Variant 1, the longitudinally substantially center portion of the second outer side surface 222A is fastened to the ground plate 50A by the bolt 240 and the nut 250. Accordingly, even if the mounting portion 270 according to the embodiment is not used, the stress generated in the bracket 230 is reduced with the cover 220 and the ground plate 50A fastened to each other. When the mounting portion 270 is not necessary, there is no need to form a mounting hole for attaching the mounting portion 270 to the ground plate 50A. The cost of processing the ground plate 50A can be suppressed accordingly.

In the mounting structure 20A according to Variant 1, the first engaging portion 224 and the pair of first ribs 226 are also provided on the first outer side surface 222 of the cover 220. In the mounting structure 20A according to Variant 1, therefore, the cover 220 and the ground plate 50A can be also fastened to each other by using the first engaging portion 224 and the pair of first ribs 226 provided on the first outer side surface 222. The same cover 220 can be therefore used both when the cover 220 and the ground plate 50A are fastened to each other by using the first engaging portion 224 and the pair of first ribs 226 provided on the first outer side surface 222 and when the cover 220 and the ground plate 50A are fastened to each other by using the second engaging portion 224A and the pair of second ribs 226A provided on the second outer side surface 222A.

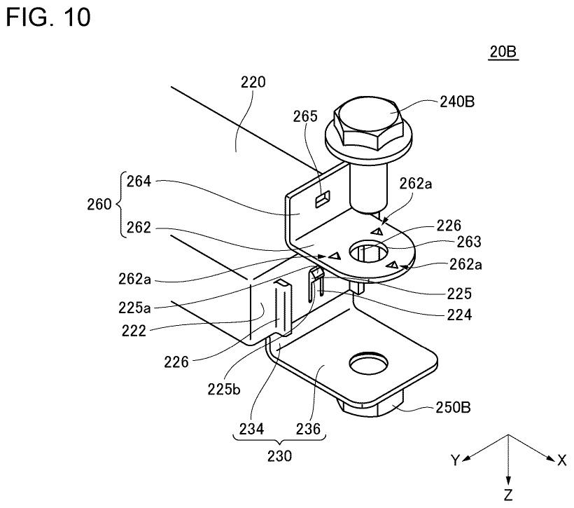

FIG. 10 is an exploded perspective view of a part of a mounting structure 20B according to Variant 2. The mounting structure 20B according to Variant 2 is the same as the mounting structure 20 according to the embodiment except for the following points.

In the mounting structure 20B according to Variant 2, the bolt 240B and the nut 250B are also fastening portions that fasten the set of the chassis 210, the cover 220, and the bracket 230 that are integrated, the washer 260, and the ground plate 50 to each other. The bolt 240B and the nut 250B are attachable to and detachable from each other.

In the mounting structure 20B according to Variant 2, the bracket 230 and the nut 250B are integrated with each other. Specifically, the +Z side surface of the drawn portion 236 and the −Z side surface of the nut 250B are integrated with each other by a joining method such as welding. Accordingly, the cover 220 and the ground plate 50 can be fastened to each other by the bolt 240B and the nut 250B without joining the nut 250B and the ground plate 50 in advance by a joining method such as welding. The bolt 240B is capable of extending through the through-hole 263 and the drawn portion 236 from the −Z side substantially parallel to the Z direction. As a result, the bolt 240B can be attached to the nut 250B from the −Z side end portion of the nut 250B by rotating the bolt 240B in the tightening direction of the bolt 240B and the nut 250B while the bolt 240B extends through the through-hole 263 and the drawn portion 236 from the −Z side.

An example of a method of attaching the amplifier substrate 110 and the ground plate 50 to each other by the mounting structure 20B according to Variant 2 will be described. In the example of the attachment method in the mounting structure 20B according to Variant 2, the amplifier substrate 110 and the ground plate 50 are attached to each other by the mounting structure 20B in the same manner as the mounting structure 20 according to the embodiment, except for the following points.

First, a chassis 210, a bracket 230, and a nut 250B that are integrated in advance are prepared. Next, the amplifier substrate 110 is mounted on the −Z side surface of the chassis 210 in the same manner as the mounting structure 20 according to the embodiment. Next, the chassis 210 and the +Z side opening of the cover 220 are attached to each other in the same manner as the mounting structure 20 according to the embodiment.

Next, the washer 260 is temporarily held by the cover 220, the bracket 230, the bolt 240B, and the nut 250B. Specifically, first, the first engaging claw 225 and the engagement hole 265 are engaged with each other. Next, while the bolt 240B extends through the through-hole 263 and the drawn portion 236 from the −Z side, the bolt 240B is rotated in a tightening direction of the bolt 240B and the nut 250B to temporarily hold the bolt 240B and the nut 250B. In the mounting structure 20B according to Variant 2, as in the mounting structure 20 according to the embodiment, the first engaging claw 225 has also the first inclined surface 225a and the second inclined surface 225b, and is a restricting portion that restricts the movement direction of the washer 260 to the Z direction. In the temporary fastening of the bolt 240B and the nut 250B, therefore, the washer 260 can be inhibited from rotating around the bolt 240B even if the bolt 240B rotates.

Next, the +X side end part of the drawn portion 236 is passed through the first mounting hole 52 from the −Z side of the ground plate 50 in the same manner as the mounting structure 20 according to the embodiment. Next, the drawn portion 236 is placed on the +Z side surface side of the ground plate 50. Next, the mounting portion 270 is attached to the second mounting hole 54 of the ground plate 50 in the same manner as the mounting structure 20 according to the embodiment.

Next, the bolt 240B is rotated in a fastening direction of the bolt 240B and the nut 250B to fasten the bolt 240B and the nut 250B to each other. As the bolt 240B is rotated in the tightening direction of the bolt 240B and the nut 250B, the contact portion 262 is lifted toward the +Z side by the bolt 240B until the +Z side surface of the contact portion 262 and the −Z side surface of the ground plate 50 come into contact with each other. As a result, the contact claw 262a can be brought into contact with the −Z side surface of the ground plate 50 in the same manner as in the mounting structure 20 of the embodiment. In the mounting structure 20B according to Variant 2, the pair of first ribs 226 and the extending portion 264 are also restricting portions that restrict the movement direction of the washer 260 to the Z direction during the fastening operation of the bolt 240B and the nut 250B. The washer 260 during the fastening operation of the bolt 240B and the nut 250B moves along the first outer side surface 222. The configuration of the restricting portion may be a pair of first ribs 226 and the extending portion 264, and the first engaging claw 225 may not be included in the configuration of the restricting portion.

Next, an example of a method of replacing the washer 260 in the mounting structure 20B according to Variant 2 will be described.

First, the bolt 240B is rotated in a direction opposite to a direction in which the bolt 240B and the nut 250B are fastened to each other, to loosen the bolt 240B and the nut 250B. The bolt 240B moves toward the −Z side by rotating the bolt 240B in a direction opposite to a direction in which the bolt 240B and the nut 250B are fastened to each other. The contact portion 262 moves toward the −Z side together with the bolt 240B due to the weight of the contact portion 262. In the mounting structure 20B according to Variant 2, as in the mounting structure 20 according to the embodiment, the contact portion 262 can be also moved toward the −Z side together with the bolt 240B with the −Z side end part of the extending portion 264 hooked on the second inclined surface 225b. In the mounting structure 20B according to Variant 2, therefore, as in the mounting structure 20 according to the embodiment, the washer 260 can be also prevented from falling off when loosening the bolt 240B and the nut 250B from each other as compared with the case where the −Z side end portion of the extending portion 264 and the second inclined surface 225b of the first engaging claw 225 are spaced from each other by a relatively long distance.

In addition, since the −Z side end portion of the extending portion 264 and the second inclined surface 225b of the first engaging claw 225 are in contact with each other, the occurrence of a strange sound due to vibration can be suppressed in the same manner as in the mounting structure 20 according to the embodiment.

Next, the bolt 240B is detached from the −Z side end portion of the nut 250B. Next, the washer 260 is detached from the cover 220 and the bolt 240. Next, a new washer 260 is prepared. The new washer 260 is locked to the ground plate 50 in the same manner as the method described above. In the mounting structure 20B according to Variant 2, the washer 260 can be also replaced without removing the amplifier substrate 110 as in the mounting structure 20 according to the embodiment.

Although the embodiments and variants of the present invention have been described above with reference to the accompanying drawings, these are merely examples of the present invention, and various other configurations may be employed.

According to the present specification, the following aspects of the mounting structure and the antenna device are provided.

### Aspect 1

In Aspect 1, a mounting structure includes an accommodation portion accommodating a substrate, a fastening portion to fasten the accommodation portion and a ground plate to each other, a locking portion to be locked to the ground plate by a fastening operation of the fastening portion, and a restricting portion to restrict a movement direction of the locking portion during the fastening operation of the fastening portion.

The “substrate” corresponds to the “amplifier substrate” of the embodiment and variants described above. The “accommodation portion” corresponds to the “chassis” and the “cover” of the embodiment and variants described above. The “fastening portion” corresponds to the “bolt” and the “nut” in the embodiment and variants described above. The “locking portion” corresponds to the “washer” of the embodiment and variants described above. The “restricting portion” corresponds to the “first rib”, the “second rib”, the “extending portion”, the “first engaging claw”, and the “second engaging claw” in the embodiment and variants described above.

According to the aspect described above, the restricting portion can restrain the locking portion from moving in a direction different from the fastening direction of the fastening portion due to the fastening operation of the fastening portion. As a result, the device including the substrate can be stably grounded to the ground plate.

### Aspect 2

In Aspect 2, the locking portion has a claw to contact the ground plate by the fastening operation of the fastening portion.

The “claw” corresponds to the “contact claw” of the embodiment and variants described above.

According to the aspect described above, even if an insulating film is present on the surface of the ground plate, the insulating film on the surface of the ground plate can be broken by the claw. Accordingly, the locking portion and the ground plate can be electrically connected to each other with ease as compared with the case where the claw is not provided. According to the aspect described above, the restricting portion can restrain the rotation of the claw due to the fastening operation of the fastening portion. The variation in the contact position between the claw and the ground plate due to the rotation of the claw can be reduced accordingly.

### Aspect 3

In Aspect 3, the accommodation portion and at least a part of the fastening portion are attached to each other.

According to the aspect described above, the accommodation portion and the ground plate can be fastened to each other by the fastening portion without joining the fastening portion and the ground plate to each other in advance by a joining method such as welding. Accordingly, the human-hour for processing the ground plate can be suppressed because the work such as the bonding step can be reduced as compared with the case where the fastening portion and the ground plate are joined to each other in advance.

### Aspect 4

In Aspect 4, the restricting portion includes a structure located at least in part around the locking portion.

The “structure” corresponds to the “first rib” and the “second rib” of the embodiment and variants described above.

According to the aspect described above, the structure can restrain the rotation of the locking portion due to the fastening operation of the fastening portion.

### Aspect 5

In Aspect 5, the mounting structure further includes an engaging portion engageable with the locking portion from a lateral side of the movement direction of the locking portion.

The “engaging portion” corresponds to the “first engaging portion” and the “second engaging portion” of the embodiment and variants described above.

According to the aspect described above, the locking portion can be temporarily held by the engaging portion during the fastening operation of the fastening portion. As a result, the movement direction of the locking portion can be restricted. According to the aspect described above, the engagement between locking portion and the engaging portion can be released from each other by the fastening operation of the fastening portion.

### Aspect 6

In Aspect 6, the locking portion and the engaging portion are in contact with each other with the accommodation portion and the ground plate fastened to each other.

According to the aspect described above, the collision between the locking portion and the engaging portion due to vibration can be suppressed as compared with the case where a minute clearance is present between the locking portion and the engaging portion. As a result, the occurrence of a strange sound due to the collision between the locking portion and the engaging portion can be suppressed. According to the aspect described above, the locking portion can be easily restrained from falling off when loosening the fastening of the fastening portion as compared with the case where the locking portion and the engaging portion are spaced from each other by a relatively long distance.

### Aspect 7

In Aspect 7, the locking portion moves along an outer surface of the accommodation portion in the fastening operation of the fastening portion.

According to the aspect described above, as the locking portion is moved along the outer surface of the accommodation portion by the fastening operation of the fastening portion, it can be restrained from moving in a direction different from the fastening direction of the fastening portion. As a result, the device including the substrate can be stably grounded to the ground plate.

### Aspect 8

In Aspect 8, an antenna device includes the mounting structure described above and an antenna electrically connected to the substrate.

The “antenna” corresponds to the “glass antenna” of the embodiment and variants described above.

According to the aspect described above, the device including the substrate can be stably grounded to the ground plate as in the aspect 1.

### Aspect 9

In Aspect 9, a mounting structure includes an accommodation portion accommodating a substrate and including an outer surface, a fastening portion to fasten the accommodation portion and a ground plate to each other, and a locking portion to be locked to the ground plate by a fastening operation of the fastening portion, and the locking portion moves along the outer surface of the accommodation portion in the fastening operation of the fastening portion.

According to the aspect described above, as the locking portion is moved along the outer surface of the accommodation portion by the fastening operation of the fastening portion, it can be restrained from moving in a direction different from the fastening direction of the fastening portion. As a result, the device including the substrate can be stably grounded to the ground plate.

This application claims priority based on Japanese Patent Application No. 2023-043800 filed on Mar. 20, 2023, the entire disclosure of which is incorporated herein by reference.

### REFERENCE SIGNS LIST

1 vehicle, 10 antenna device, 20, 20A, 20B mounting structure, 50 ground plate, 50A ground plate, 52 first mounting hole, 52A mounting hole, 54 second mounting hole, 60 rear window, 110 amplifier substrate, 120 antenna terminal, 210 chassis, 220 cover, 222 first outer side surface, 222A second outer side surface, 224 first engaging portion, 224A second engaging portion, 225 first engaging claw, 225A second engaging claw, 225a first inclined surface, 225b second inclined surface, 226 first rib, 226A second rib, 230 bracket, 232 proximal end portion, 234 stepped portion, 236 drawn portion, 240, 240B bolt 250, 250B nut, 260 washer, 262 contact portion, 262a contact claw, 263 through-hole, 264 extending portion, 265 engagement hole, 270 mounting portion, 272 mounting extending portion

1. A mounting structure comprising:
an accommodation portion accommodating a substrate;
a fastening portion to fasten the accommodation portion and a ground plate to each other;
a locking portion to be locked to the ground plate by a fastening operation of the fastening portion; and
a restricting portion to restrict a movement direction of the locking portion during the fastening operation of the fastening portion.

2. The mounting structure according to claim 1,
wherein the locking portion has a claw to contact the ground plate by the fastening operation of the fastening portion.

3. The mounting structure according to claim 1,
wherein the accommodation portion and at least a part of the fastening portion are attached to each other.

4. The mounting structure according to claim 1,
wherein the restricting portion includes a structure located at least in part around the locking portion.

5. The mounting structure according to claim 1, further comprising:
an engaging portion engageable with the locking portion from a lateral side of the movement direction of the locking portion.

6. The mounting structure according to claim 5,
wherein the locking portion and the engaging portion are in contact with each other with the accommodation portion and the ground plate fastened to each other.

7. The mounting structure according to claim 1,
wherein the locking portion moves along an outer surface of the accommodation portion in the fastening operation of the fastening portion.

8. An antenna device comprising:
the mounting structure according to claim 1; and
an antenna electrically connected to the substrate.

9. A mounting structure comprising:
an accommodation portion accommodating a substrate and including an outer surface;
a fastening portion to fasten the accommodation portion and a ground plate to each other; and
a locking portion to be locked to the ground plate by a fastening operation of the fastening portion,
wherein the locking portion moves along the outer surface of the accommodation portion in the fastening operation of the fastening portion.
